(19) United States
(12) Patent Application Publication
(10) Pub. No.: US 2018/0315082 A1
(43) Pub. Date: Nov. 1, 2018

(54) SIMULATING PERFORMANCE OF A NETWORK-TRANSFERRED ELECTRONIC CONTENT ITEM

(71) Applicant: Microsoft Technology Licensing, LLC, Redmond, WA (US)

(72) Inventors: Yuan Gao, Sunnyvale, CA (US); Huiji Gao, San Jose, CA (US); Kun Liu, San Jose, CA (US); Liqin Xu, Fremont, CA (US)

(21) Appl. No.: 15/581,836

(22) Filed: Apr. 28, 2017

(51) Int. Cl. G06Q 30/02

(52) U.S. Cl. CPC G06Q 30/0254; G06Q 30/0275

(57) ABSTRACT

Techniques for simulating performance of a content delivery campaign are provided. In one technique, multiple entities that satisfy one or more criteria associated with a content delivery campaign are identified. For each entity, multiple content item selection events in which that entity participated are identified and data associated with each of the content item selection events are aggregated to generate aggregated data. The aggregated data associated with each entity is combined to generate combined aggregated data. The combined aggregated data is adjusted based on an actual performance value of the content delivery campaign to generate adjusted aggregated data. In response to receiving input, determining, based on the adjusted aggregated data and the input, a simulated performance of the content delivery campaign.

### TECHNICAL FIELD

The present disclosure relates to performance simulation and, more particularly, to analyzing past content item selection events to simulate performance of a content item campaign. SUGGESTED CLASSIFICATION: 703/4; SUGGESTED ART UNIT: 2123.

### BACKGROUND

A goal of many providers of online content is to provide high quality and highly relevant content to many users to induce users to perform some action, such as viewing online video, sharing content with connections in a social network, etc. In some online scenarios, multiple content providers are competing for the same online real estate in which to display their respective digital content. Such a competition is referred to herein as a “content item selection event” where multiple content items are considered for transmitting over a computer network in response to a content request and only a strict subset of the considered content items are selected.

Many factors may go into determining which content item(s) to select during a content item selection event. Factors may include objective measures of quality of the content items, past performance of the content items, and attributes of the computing device that initiated the content request. However, it is difficult for a content provider to know how their respective content items would have performed if one or more of those factors was different. Current approaches to simulating performance of content item selection events are deficient in a number of ways, including requiring a significant amount of computer resources and not considering other factors, such as content item selection events that might have occurred if certain factors were changed.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts a system for distributing content items to one or more computing devices, in an embodiment;

FIG. 2 is a flow diagram that depicts a process for simulating performance of a content delivery campaign, in an embodiment;

FIG. 3 depicts example histograms indicating frequencies of sets of content item selection events, each set sharing a characteristic, in an embodiment;

FIG. 4A includes graphs that show an effect of scaling a set of aggregated data based on actual performance data, in an embodiment;

FIG. 4B includes graphs that allow a user to view simulated performance data based on different inputs, in an embodiment;

FIG. 5 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Techniques for simulating performance of a content delivery campaign are described herein. In one technique, entities that are targeted by a content delivery campaign are identified. For each entity, the content item selection events in which that entity participated are identified. Data associated with each identified content item selection event is aggregated to generate aggregated data. The aggregated data may be adjusted or modified based on actual performance data of the content delivery campaign, if available. Then, in response to receiving first input, a first simulated performance of the content delivery campaign is determined based on the (e.g., adjusted) aggregated data and the first input. If further input is received, then a second simulated performance is determined based on the (adjusted) aggregated data and the further input.

In one technique, the aggregated data is modeled as a histogram of values, where each value corresponds to a different bucket or range of values. In another technique, the aggregated data is first scaled or adjusted based on one or more known/actual performance values. Thus, determining simulated performance is based on the scaling/adjustment.

### System Overview

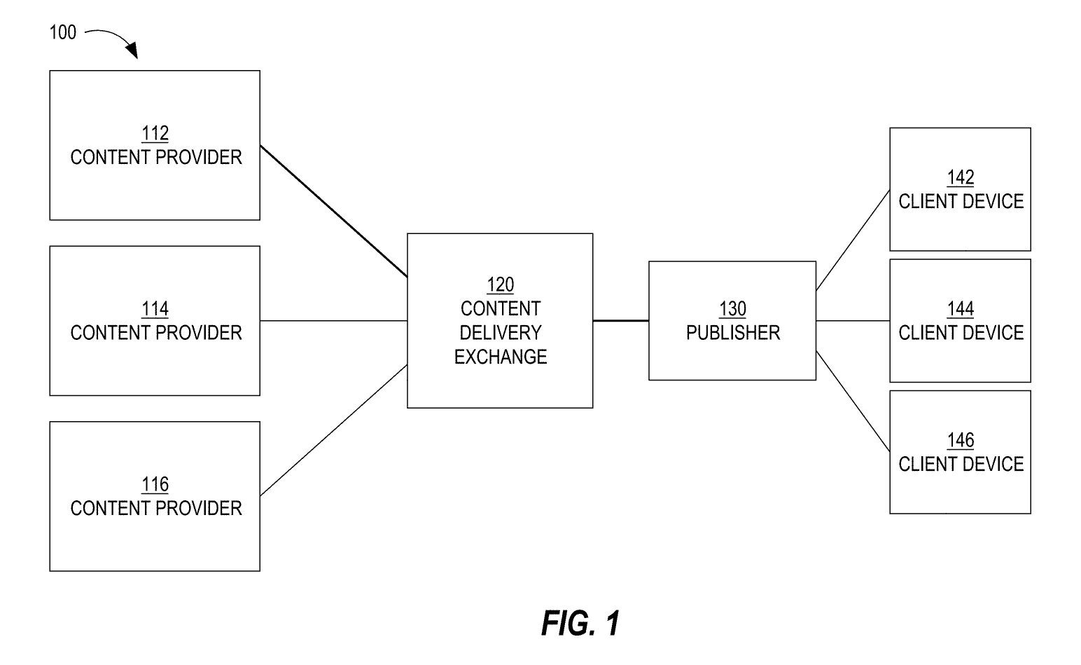

FIG. 1 is a block diagram that depicts a system 100 for distributing content items to one or more computing devices, in an embodiment. System 100 includes content providers 112-116, a content delivery exchange 120, a publisher 130, and client devices 142-146. Although three content providers are depicted, system 100 may include more or less content providers. Similarly, system 100 may include more than one publisher and more or less client devices.

Content providers 112-116 interact with content delivery exchange 120 (e.g., over a network, such as a LAN, WAN, or the Internet) to enable content items to be presented, though publisher 130, to end-users operating client devices 142-146. Thus, content providers 112-116 provide content items to content delivery exchange 120, which in turn selects content items to provide to publisher 130 for presentation to users of client devices 142-146. However, at the time that content provider 112 registers with content delivery exchange 120, neither party may know which end-users or client devices will receive content items from content provider 112, unless a target audience specified by content provider 112 is small enough.

An example of a content provider includes an advertiser. An advertiser of a product or service may be the same party as the party that makes or provides the product or service. Alternatively, an advertiser may contract with a producer or service provider to market or advertise a product or service provided by the producer/service provider. Another example of a content provider is an online ad network that contracts with multiple advertisers to provide content items (e.g., advertisements) to end users, either through publishers directly or indirectly through content delivery exchange 120.

Publisher 130 provides its own content to client devices 142-146 in response to requests initiated by users of client devices 142-146. The content may be about any topic, such as news, sports, finance, and traveling. Publishers may vary greatly in size and influence, such as Fortune 500 companies, social network providers, and individual bloggers. A content request from a client device may be in the form of a HTTP request that includes a Uniform Resource Locator (URL) and may be issued from a web browser or a software application that is configured to only communicate with publisher 130 (and/or its affiliates). A content request may be a request that is immediately preceded by user input (e.g., selecting a hyperlink on web page) or may initiated as part of a subscription, such as through a Rich Site Summary (RSS) feed. In response to a request for content from a client device, publisher 130 provides the requested content (e.g., a web page) to the client device.

Simultaneously or immediately before or after the requested content is sent to a client device, a content request is sent to content delivery exchange 120. That request is sent (over a network, such as a LAN, WAN, or the Internet) by publisher 130 or by the client device that requested the original content from publisher 130. For example, a web page that the client device renders includes one or more calls (or HTTP requests) to content delivery exchange 120 for one or more content items. In response, content delivery exchange 120 provides (over a network, such as a LAN, WAN, or the Internet) one or more particular content items to the client device directly or through publisher 130. In this way, the one or more particular content items may be presented (e.g., displayed) concurrently with the content requested by the client device from publisher 130.

Content delivery exchange 120 and publisher 130 may be owned and operated by the same entity or party. Alternatively, content delivery exchange 120 and publisher 130 are owned and operated by different entities or parties.

A content item may comprise an image, a video, audio, text, graphics, virtual reality, or any combination thereof. A content item may also include a link (or URL) such that, when a user selects (e.g., with a finger on a touchscreen or with a cursor of a mouse device) the content item, a (e.g., HTTP) request is sent over a network (e.g., the Internet) to a destination indicated by the link. In response, content of a web page corresponding to the link may be displayed on the user's client device.

Examples of client devices 142-146 include desktop computers, laptop computers, tablet computers, wearable devices, video game consoles, and smartphones.

### Bidders

In a related embodiment, system 100 also includes one or more bidders (not depicted). A bidder is a party that is different than a content provider, that interacts with content delivery exchange 120, and that bids for space (on one or more publishers, such as publisher 130) to present content items on behalf of multiple content providers. Thus, a bidder is another source of content items that content delivery exchange 120 may select for presentation through publisher 130. Thus, a bidder acts as a content provider to content delivery exchange 120 or publisher 130. Examples of bidders include AppNexus, DoubleClick, and LinkedIn. Because bidders act on behalf of content providers (e.g., advertisers), bidders create content delivery campaigns and, thus, specify user targeting criteria and, optionally, frequency cap rules, similar to a traditional content provider.

In a related embodiment, system 100 includes one or more bidders but no content providers. However, embodiments described herein are applicable to any of the above-described system arrangements.

### Content Delivery Campaigns

Each content provider establishes a content delivery campaign with content delivery exchange 120. A content delivery campaign includes (or is associated with) one or more content items. Thus, the same content item may be presented to users of client devices 142-146. Alternatively, a content delivery campaign may be designed such that the same user is (or different users are) presented different content items from the same campaign. For example, the content items of a content delivery campaign may have a specific order, such that one content item is not presented to a user before another content item is presented to that users.

A content delivery campaign has a start date/time and, optionally, a defined end date/time. For example, a content delivery campaign may be to present a set of content items from Jun. 1, 2017 to Aug. 1, 2017, regardless of the number of times the set of content items are presented (“impressions”), the number of user selections of the content items (e.g., click throughs), or the number of conversions that resulted from the content delivery campaign. Thus, in this example, there is a definite (or “hard”) end date. As another example, a content delivery campaign may have a “soft” end date, where the content delivery campaign ends when the corresponding set of content items are displayed a certain number of times, when a certain number of users view, select or click on the set of content items, or when a certain number of users performing a particular action associated with the content delivery campaign, such as purchase a product/service or fill out a particular form on a website.

A content delivery campaign may specify one or more targeting criteria that are used to determine whether to present a content item of the content delivery campaign to one or more users. Example factors include date of presentation, time of day of presentation, characteristics of a user to which the content item will be presented, attributes of a computing device that will present the content item, identity of the publisher, etc. Examples of characteristics of a user include demographic information, residence information, job title, employment status, academic degrees earned, academic institutions attended, former employers, current employer, number of connections in a social network, number and type of skills, number of endorsements, and stated interests. Examples of attributes of a computing device include type of device (e.g., smartphone, tablet, desktop, laptop), current geographical location, operating system type and version, size of screen, etc.

For example, targeting criteria of a particular content delivery campaign may indicate that a content item is to be presented to users with at least one undergraduate degree, who are unemployed, who are accessing from South America, and where the request for content items is initiated by a smartphone of the user. If content delivery exchange 120 receives, from a computing device, a request that does not satisfy the targeting criteria, then content delivery exchange 120 ensures that any content items associated with the particular content delivery campaign are not sent to the computing device.

Instead of one set of targeting criteria, the same content delivery campaign may be associated with multiple sets of targeting criteria. For example, one set of targeting criteria may be used during one period of time of the content delivery campaign and another set of targeting criteria may be used during another period of time of the campaign. As another example, a content delivery campaign may be associated with multiple content items, one of which may be associated with one set of targeting criteria and another one of which is associated with a different set of targeting criteria. Thus, while one content request from publisher 130 may not satisfy targeting criteria of one content item of a campaign, the same content request may satisfy targeting criteria of another content item of the campaign.

Different content delivery campaigns that content delivery exchange 120 manages may have different compensation schemes. For example, one content delivery campaign may compensate content delivery exchange 120 for each presentation of a content item from the content delivery campaign (referred to herein as cost per impression or CPM). Another content delivery campaign may compensate content delivery exchange 120 for each time a user interacts with a content item from the content delivery campaign, such as selecting or clicking on the content item (referred to herein as cost per click or CPC). Another content delivery campaign may compensate content delivery exchange 120 for each time a user performs a particular action, such as purchasing a product or service, downloading a software application, or filling out a form (referred to herein as cost per action or CPA). Content delivery exchange 120 may manage only campaigns that are of the same type of compensation scheme or may manage campaigns that are of any combination of the three types of compensation scheme.

### Content Item Selection Events

As described previously, a content item selection event is when multiple content items are considered and a subset selected for presentation on a computing device in response to a request. Thus, each content request that content delivery exchange 120 receives triggers a content item selection event.

Specifically, in response to receiving a content request, content delivery exchange 120 analyzes multiple content delivery campaigns to determine whether attributes associated with the content request (e.g., attributes of a user that initiated the content request, attributes of a computing device operated by the user, current date/time) satisfy targeting criteria associated with each of the analyzed content delivery campaigns. If so, the content delivery campaign is considered a candidate content delivery campaign. One or more filtering criteria may be applied to a set of candidate content delivery campaigns to reduce the total number of candidates.

A final set of candidate content delivery campaigns is ranked based on one or more criteria, such as predicted click-through rate (which may be relevant only for CPC campaigns), effective cost per impression (which may be relevant to CPC, CPM, and CPA campaigns), and/or bid price. Each content delivery campaign may be associated with a bid price that represents how much the corresponding content provider is willing to pay (e.g., content delivery exchange 120) for having a content item of the campaign presented to an end-user or selected by an end-user. Different content delivery campaigns may have different bid prices. Generally, content delivery campaigns associated with relatively higher bid prices will be selected for displaying their respective content items relative to content items of content delivery campaigns associated with relatively lower bid prices. Other factors may limit the effect of bid prices, such as objective measures of quality of the content items (e.g., actual click-through rate (CTR) and/or predicted CTR of each content item), budget pacing (which controls how fast a campaign's budget is used and, thus, may limit a content item from being displayed at certain times), frequency capping (which limits how often a content item is presented to the same person), and a domain of a URL that a content item might include.

An example of a content item selection event is an advertisement auction, or simply an “ad auction.”

In one embodiment, content delivery exchange 120 conducts one or more content item selection events. Thus, content delivery exchange 120 has access to all data associated with making a decision of which content item(s) to select, including bid price of each campaign in the final set of content delivery campaigns, an identity of an end-user to which the selected content item(s) will be presented, an indication of whether a content item from each campaign was presented to the end-user, a predicted CTR of each campaign, a CPC or CPM of each campaign.

In another embodiment, an exchange that is owned and operated by an entity that is different than the entity that owns and operates content delivery exchange 120 conducts one or more content item selection events. In this latter embodiment, content delivery exchange 120 sends one or more content items to the other exchange, which selects one or more content items from among multiple content items that the other exchange receives from multiple sources. In this embodiment, content delivery exchange 120 does not know (a) which content item was selected if the selected content item was from a different source than content delivery exchange 120 or (b) the bid prices of each content item that was part of the content item selection event. Thus, the other exchange may provide, to content delivery exchange 120 (or to a performance simulator described in more detail herein), information regarding one or more bid prices and, optionally, other information associated with the content item(s) that was/were selected during a content item selection event.

### Tracking User Interaction

Content delivery exchange 120 tracks one or more types of user interaction across client devices 142-146. For example, content delivery exchange 120 determines whether a content item that exchange 120 delivers is displayed by a client device. Such a “user interaction” is referred to as an “impression.” As another example, content delivery exchange 120 determines whether a content item that exchange 120 delivers is selected by a user of a client device. Such a “user interaction” is referred to as a “click.” Content delivery exchange 120 stores such data as user interaction data, such as an impression data set and/or a click data set.

For example, content delivery exchange 120 receives impression data items, each of which is associated with a different instance of an impression and a particular content delivery campaign. An impression data item may indicate a particular content delivery campaign, a specific content item, a date of the impression, a time of the impression, a particular publisher or source (e.g., onsite v. offsite), a particular client device that displayed the specific content item, and/or a user identifier of a user that operates the particular client device. Thus, if content delivery exchange 120 manages multiple content delivery campaigns, then different impression data items may be associated with different content delivery campaigns. One or more of these individual data items may be encrypted to protect privacy of the end-user.

Similarly, a click data item may indicate a particular content delivery campaign, a specific content item, a date of the user selection, a time of the user selection, a particular publisher or source (e.g., onsite v. offsite), a particular client device that displayed the specific content item, and/or a user identifier of a user that operates the particular client device.

### Process Overview

Embodiments are described herein for simulating performance of a content delivery campaign. For example, the content delivery campaign may have been active for a period of time with a bid price of B1. Embodiments address the scenario if the bid price is changed to B2. As described in more detail herein, performance includes number of impressions, the number of user selections (e.g., clicks), and cost incurred.

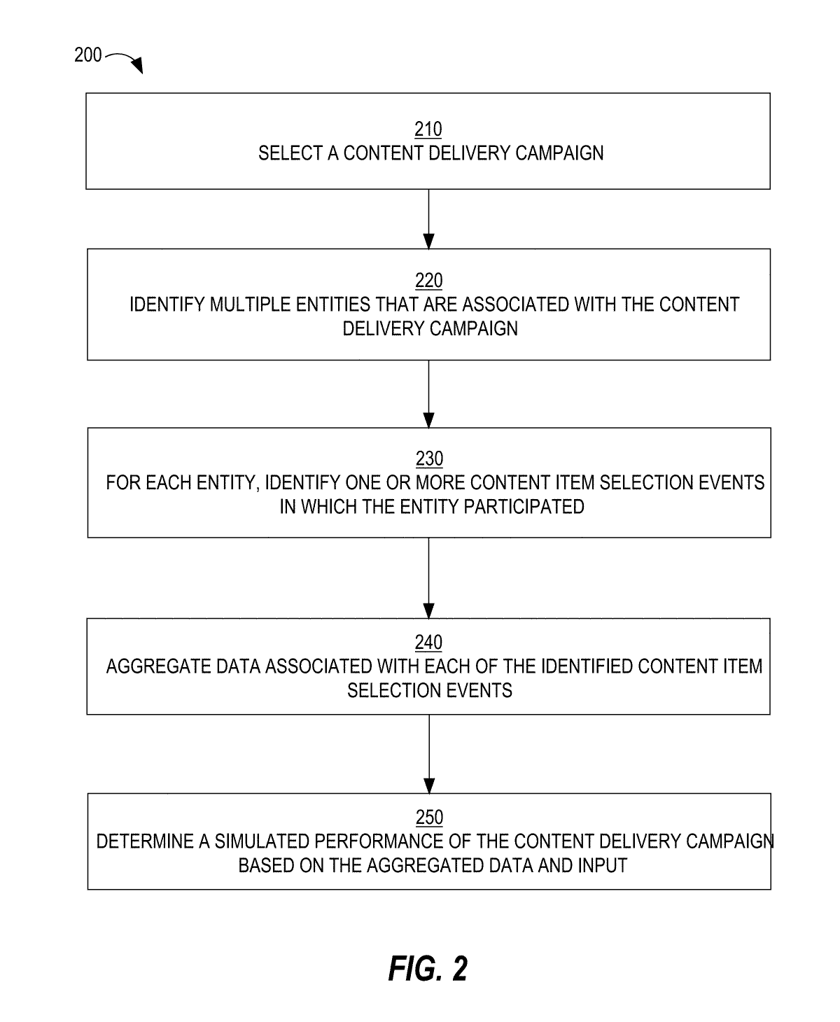

FIG. 2 is a flow diagram that depicts a process 200 for simulating performance of a content delivery campaign, in an embodiment. Process 200 may be implemented by content delivery exchange 120 or by a performance simulator associated with content delivery exchange 120. If the latter, the performance simulator is implemented in hardware, software, or any combination of hardware and software.

At block 210, a content delivery campaign is selected. Block 210 may be performed based on input from a content provider that provided the content delivery campaign.

Alternatively, block 210 is performed automatically such as content delivery campaign is selected without requiring user input to affirmatively select the content delivery campaign. If so, then one or more criteria may be considered in determining which content delivery campaign to select. For example, a content delivery campaign that has been active for a certain period of time (e.g., one week or three days) is selected. As another example, a content delivery campaign that has been in a final set of candidate campaigns of three thousand content item selection events is selected.

As another example, a content delivery campaign that is associated with a threshold number of user interactions is selected. As a specific example, a content delivery campaign is selected if (a) a content item from the content delivery campaign has been presented (e.g., displayed or played, if the content item is an audio item or a video item) two thousand times or has been selected (e.g., “clicked”) by a user fifty times or (b) a particular action (e.g., purchased a product, filled out an electronic form, watched a particular video) has been performed by users ten times. In these examples, a content delivery campaign has a history of being active and, therefore, statistics regarding the campaign's performance may be analyzed.

At block 220, multiple entities that satisfy one or more criteria associated with the content delivery campaign (selected in block 210) are identified. An entity is any entity that may be the target of a content delivery campaign. Typical content delivery campaigns target human users, but may target non-human users. Thus, an entity may be a human user, a group of people, an organization (e.g., civic, business, or government organization), a computing device, a computer network, a website, etc.

The one or more criteria associated with the content delivery campaign are one or more targeting criteria that are used to determine whether a content item of the content delivery campaign should be presented to an entity associated with a content request.

At block 230, for each entity identified in block 220, one or more content item selection events in which the entity participated are identified. Thus, if two entities were identified in block 220 and entity A participated in four content item selection events and entity B participated in thirteen content item selection events, then seventeen content item selection events would be identified at block 230.

At block 240, data associated with each of the content item selection events identified in block 230 is aggregated to generate aggregated data. Block 240 may involve first aggregating data on a per entity (e.g., per user) basis and then combining (e.g., summing) the aggregated data for all entities identified in block 220 to generate combined aggregated data. However, there is no requirement that data associated with all content item selection events of one entity need to be aggregated before being combined with data associated with a content item selection event of another entity.

In an embodiment, the data that is aggregated is a bid price associated with each content item selection event. The bid price may be the minimum winning bid price. Different content item selection events are associated with different winning bid prices. A minimum winning bid price may be defined as the highest bid price of the content item that was not selected as part of a content item selection event. For example, if a content item selection event involved four content items (content items A, B, C, and D), only content item A was selected, and content item B is associated with (or “has”) the highest bid price of content items B, C, and D, then the bid price of content item B is identified as the minimum winning bid price for that content item selection event.

Alternatively, a minimum winning bid price may be defined as the lowest bid price of the content item that was selected as part of a content item selection event. For example, if a content item selection event involved four content items (content items A, B, C, and D), content items A and B were selected, and content item B has a lower bid price than content item A, then the bid price of content item B is identified as the minimum winning bid price for that content item selection event.

Alternatively, a minimum winning bid price may be defined as a bid price between (1) the lowest bid price of the content item that was selected as part of a content item selection event and (2) the highest bid price of the content item that was not selected as part of the content item selection event. For example, if a content item selection event involved four content items (content items A, B, C, and D), content items A and B were selected, content item B has a lower bid price than content item A, and content item C has a higher bid price than content item D, then a bid price between the bid price of content item B and the bid price of content item C is determined to be the minimum winning bid price for that content item selection event. For example, the bid price may be exactly between those two bid prices.

A result of block 240 is a set of values, each indicating a number of times a bid price (or a range of bid prices) is identified while analyzing content item selection events identified in block 230. If individual bid prices vary greatly, then individual bid prices may be organized into buckets, each bucket corresponding to a different range of bid prices. For example, a first bucket may correspond to bid prices $2.01 to $2.25 and a second (subsequent) bucket may correspond to bid prices $2.26-$2.50. The first bucket may indicate ten (meaning that ten content item selection events are associated with bid prices that are in between $2.01 and $2.25) and the second bucket may indicate eighteen (meaning that eighteen content item selection events are associated with bid prices that are in between $2.26 and $2.50).

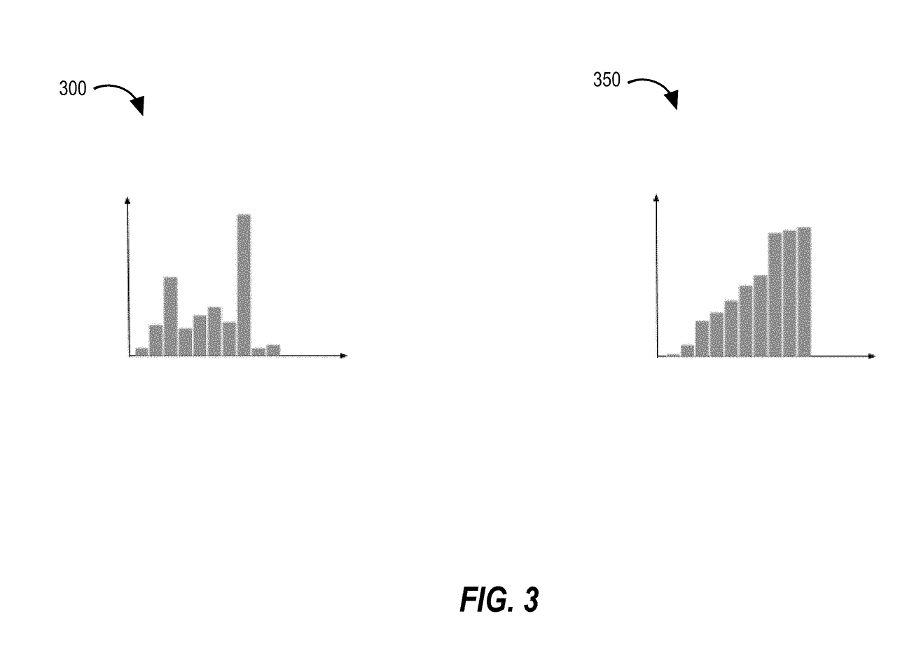

The result of block 240 may be viewed as a histogram that orders the values based on an ascending (or descending) order of bid price. Examples of histograms are depicted in FIG. 3. For histogram 300, the x-axis indicates bid price, the y-axis indicates a number of content item selection events, and each bar or bucket indicates a number of content item selection events whose associated bid price (e.g., minimum winning bid price) equals the bid price (or falls into the range of bid prices) of that bar. For example, the first bar

Block 240 may also involve determining a cumulative sum based on the values ordered by bid price. Like histogram 300, the y-axis in histogram 350 indicates a number of content item selection events. However, in histogram 350, each succeeding bar (or bucket) represents a sum of (1) the number of content item selection events whose bid price corresponds to the bucket and (2) the number of content item selection events whose bid price is less than the bid price of the bucket. Thus, a value of each succeeding bar or bucket would not be less than any previous value in the histogram. (The height of the bars in histogram 350 are not consistent with the height of the bars in histogram 300 and do not necessarily correspond to the relative values indicated in histogram 300).

At block 250, a simulated performance of the content delivery campaign is determined based on the aggregated data and input. The input may be input that is pre-defined or that is provided, for example, by an end user, such as a representative of a content provider that provided the content delivery campaign. For example, the input may be 10% indicating that (1) a value that is 10% greater than a current bid price is to be calculated and used to determine a first simulated performance and (2) a value that is 10% less than the current bid price is to be calculated and used to determine a second simulated performance. As another example, a user inputs a value on a graphical user interface displayed on a computing device of the user. The value may represent a particular bid price. The value is transmitted over a computer network to content delivery exchange 120 (or a performance simulator). In response to receiving the value, content delivery exchange 120 (or the performance simulator) determines, based on the aggregated data and the value, how the content delivery campaign might have performed based on the value. The simulated performance may in one of multiple units, depending on the type of performance being simulated, such as a number of impressions, a user selection rate (e.g., a CTR), or a cost.

### Adjusting Aggregated Data

Process 200, as described above, does not indicate whether the content delivery campaign has a history, such that actual performance of the content delivery campaign is known.

In an embodiment, the content delivery campaign has a history of being a part in a number of content item selection events. For example, the content delivery campaign may have been in a final set of content delivery campaigns of multiple content item selection events. In such an embodiment, actual performance may be known, especially if content delivery exchange 120 conducted the previous content item selection events in which the content delivery campaign was a part. In such an embodiment where actual performance of a content delivery campaign is known, such performance may be taken into account to modify the aggregated data prior to block 250.

For example, a difference between an actual performance given a particular bid price is used to adjust the aggregated data. If the aggregated data is a histogram, as described herein, then a difference between the simulated value associated with the current bid price is compared to the actual value. That difference may be applied (e.g., added or subtract) to each value (representing a number of content item selection events) in the histogram. Alternatively, a percentage difference may be calculated. For example, the difference between the simulated value and the actual value is divided by the actual value to generate a percentage difference. That percentage difference may then be applied (e.g., multiplied) to each value in the histogram. Such a process is referred to as “scaling.”

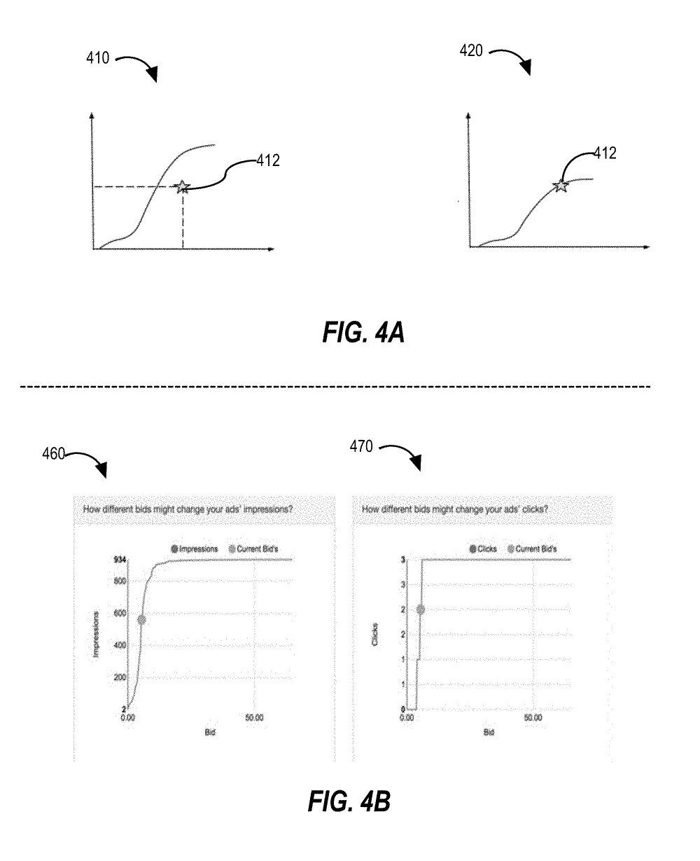

FIG. 4A includes two graphs: graph 410 that shows a simulated performance curve for a content delivery campaign prior to any scaling or adjustment and graph 420 that shows a simulated performance curve after the curve in graph 410 is scaled based on actual performance of the content delivery campaign. In each graph, the y-axis corresponds to simulated performance and the x-axis corresponds to bid price. Graphs 410 and 420 depict a point 412 that indicates actual performance (e.g., a particular number of impressions) that resulted from a bid price at that point on the graphs. For example, point 412 may associate a bid price of $3.50 (which the content delivery campaign may have had initially) with 10,890 as the actual number of impressions of one or more content items of the content delivery campaign.

The curve in either chart may be drawn by a computer process based on specific points (representing different simulated performances values at different bid prices) in a graph, such that the curve goes through each point. The curve may give the impression that the underlying value data is continuous when the value data may be discontinuous.

### Multiple Actual Performance Values

In an embodiment, there are multiple actual performance values for a content delivery campaign, each performance value corresponding to a different bid price. The content delivery campaign's simulation line (such as in graph 410) is adjusted based on the multiple actual performance values. Thus, the line is adjusted to fit the actual performance values. For example, all simulated performance values greater than the highest actual performance value are scaled based on (1) a difference between the highest actual performance value and the simulated performance value that corresponds to the highest actual performance value, all simulated performance values lower than the lowest actual performance value are scaled based on (2) a difference between the lowest actual performance value and the simulated performance value that corresponds to the lowest actual performance value, and all simulated values between two actual performance values are scaled based on a combination of (1) and (2).

### Providing Performance Simulations

In an embodiment, a user interface is provided that indicates one or more simulated performances of a content delivery campaign, regardless of whether the content delivery campaign has a history. Each simulated performance is based on a different input, such as a different bid price. The input may be provided by a user (such as a representative of the content provider) or may be determined automatically by a program or input from a configuration file.

For example, a curve (or “line”) similar to the curve in graph 420 is presented to a user via a user interface. The user interface includes one or more controls that allow the user to indicate a particular bid price and, in response to the user indication, indicate a simulated performance. For example, a user interface control comprises a selectable element that appears on a point on the curve and the user is able to move the selectable element along the curve by, for example, selecting the element with a finger (in the case of a touchscreen display) or with a mouse and corresponding cursor displayed on a screen of the computing device. As the selectable element moves along the curve, a simulated performance is determined and presented. For example, if the selectable element is currently located at a particular point on the curve, then a value indicating a particular number of impressions is presented.

FIG. 4B includes graph 460 that shows a relationship between bid price (on the x-axis) and number of impressions (on the y-axis). The circle on the curve in graph 460 is similar to point 412 in graphs 410 and 420 in that the circle indicates a current bid price, which is associated with approximately 580 impressions. The remaining points on the curve indicate the number of impressions that might result if the bid price changes.

### Simulating Bid Versus User Selection

In an embodiment, one type of simulated performance (other than number of impressions) for a content delivery campaign is user selection, an example of which is a user “click.” A simulated number of user selections may be calculated based on the set of value data (or histogram) (which may include one or more actual performance values) described previously for the content delivery campaign and a current user selection rate (an example of which is CTR) of the content delivery campaign. For example, for each bid price or bucket, the number of content item selection events associated with that bid price or bucket (as described previously, taking into consideration entities associated with the content delivery campaign) is multiplied by a current user selection rate. A line that results from the points calculated in this manner may be similar to the impression line or curve described previously, except that the y-axis is number of user selections instead of number of impressions.

In some cases, a content delivery campaign may have relatively little history or at least relatively few user selections recorded for the content delivery campaign. Therefore, in an embodiment, a user selection rate is estimated as follows:

(Clicks+alpha*segmentClicks+beta)/(Impressions+alpha*segmentImpressions+gamma)

where (1) alpha, beta, gamma are parameters (which may be pre-defined and, optionally, fixed or dynamic), (2) Clicks and Impressions are actual clicks and impressions, respectively, for the content delivery campaign during the simulation period, and (3) segmentClicks and segmentImpressions are a total number of clicks and impressions, respectively, generated from entities (e.g. all entities) targeted by the content delivery campaign.

Alpha may change based on user input or automatically based on values of other parameters. For example, as the number of Clicks and/or the number of Impressions increases, the value of alpha may decrease to a point where alpha becomes zero, such as when the number of Clicks reaches one hundred or when the number of Impressions reaches three thousand.

FIG. 4B also includes graph 470 that shows a relationship between bid price (on the x-axis) and number of clicks (on the y-axis). The circle on the curve in graph 470 is similar to point 412 in graphs 410 and 420 in that the circle indicates a current bid price, which is associated with two clicks. The remaining points on the curve indicate the number of clicks that might result if the bid price changes.

### Simulating Bid Price Versus Cost

In an embodiment, a type of simulated performance is cost. A simulated cost for a content delivery campaign may be calculated based on the set of value data (or histogram) (which may include one or more actual performance values) described previously for the content delivery campaign and a total cost per impression at each bid price or bucket. For example, for each bid price or bucket: a total cost of that bid price or bucket is calculated by (a) multiplying the number of impressions associated with that bid price or bucket (as described previously, taking into consideration entities associated with the content delivery campaign) by (b) a unit cost, or cost per impression given that bid price or bucket.

In order to calculate (b), or unit cost for a particular bid price or bucket, multiple (e.g., all) content item selection events in which the content delivery campaign actually participated are considered. For each such content item selection event, a position within a ranking of campaigns of that content item selection event is determined given the particular bid price or bucket. For example, a content item selection event has N campaigns ranked as r1>r2> . . . >rn, where ri is a ranking of campaign i and whose value is determined depending on the type of campaign, whether a CPC campaign or a CPM campaign. If campaign i is a CPC campaign, then ri is bi*pi, where bi is the bid price of campaign i and pi is the predicted/actual/estimated user selection rate of campaign i. If campaign i is a CPM campaign, then ri is bi.

The content delivery campaign under consideration may have actually ranked somewhere in the middle of a content item selection event given a previous bid price, for example, the kth position. The previous bid price is referred to as bk and the user selection rate used at that time is referred to as pk. Under a new bid price b_new, the campaign may have been ranked at a different position, such as the first or top position: b_new*pk>r1>r2> . . . >rn, where the campaign is a CPC campaign or b_new >r1>r2> . . . >rn, where the campaign is a CPM campaign.

Under “second price” content item selection events where the content provider of the winning campaign pays the second highest bid or the minimum winning bid, the unit cost for the particular bid price is calculated in one of multiple ways, depending on whether the particular campaign under consideration is a CPC campaign or a CPM campaign and whether the subsequent campaign in the ranking of campaigns in a content item selection event is a CPC campaign or a CPM campaign.

(1) If both are CPM campaigns, then the cost of that content item selection event is the bid price of the subsequent campaign (hereinafter “b2”).

(2) If both are CPC campaigns, then the cost of that content item selection event is b2*p2/pk, where p2 is the predicted/actual/estimated user selection rate of the subsequent campaign and pk is the predicted/actual/estimated user selection rate of the particular campaign under consideration.

(3) If the particular campaign under consideration is a CPM campaign and the subsequent campaign is a CPC campaign, then the cost of that content item selection event is b2*p2.

(4) If the particular campaign under consideration is a CPC campaign and the subsequent campaign is a CPM campaign, then the cost of that content item selection event is b2/pk.

The cost of using new/simulated bid price for each content item selection event in which the particular campaign participated (e.g., in a final ranking) is determined in one of the above four ways.

After the cost of each content item selection event at the new bid price or bucket is determined, the set of costs are analyzed (e.g., summed) in order to generate an average cost or a median (or other percentile) cost. The units of the average/median cost is in cost per impression. The simulated cost of the new bid price or bucket may then be determined by multiplying the average/median cost by the simulated number of impressions determined previously for that new bid price or bucket.

The above process may be repeated for each possible bid price or bucket that a user can select. The resulting simulated cost values may be plotted on a graph (e.g., similar to FIG. 4), where a user is able to select different bid prices and see what the simulated cost might be for each selected bid price.

### Benefits of Embodiments

Embodiments described herein involve a simulation approach that is target-based, instead of replay-based (where only the content item selection events (e.g., auctions) in which a content delivery campaign participated are considered). In the simulation approach described herein, the entities that are targeted by a content delivery campaign are considered. An advantage of this approach is that when a bid price of a content delivery campaign is increased, the content delivery campaign will participate in new content item selection events associated with the targeted entities. These “extra” impressions/selections/cost are captured in embodiments described herein, in contrast to the replay-based approach that neglects these factors. Such “extra” events from the target-based approach result in improved accuracy of the performance simulation.

Another benefit of embodiments described herein is efficiency. The replay-based approach requires replay of every content item selection event under a new bid price for every content item of a content delivery campaign. For example, there are a total of N content items and B bids to simulate. During the period under concern, there are M users, and on average K content item selection events per user. Then the total time complexity is O(N*B*M*K). Under the target-based approach, the time complexity is O(B*M*K).

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

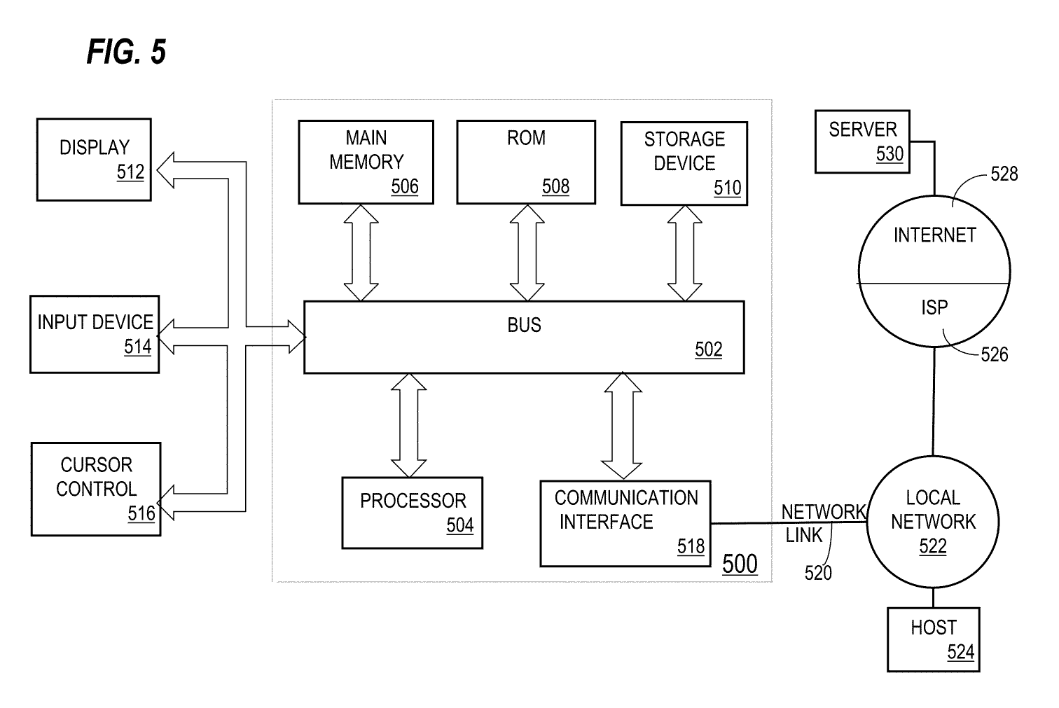

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or solid-state drive is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 510. Volatile media includes dynamic memory, such as main memory 506. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A system comprising:
one or more processors;
one or more storage media storing instructions which, when executed by the one or more processors, cause:
identifying a plurality of entities that satisfy one or more criteria associated with a content delivery campaign;
for each entity in the plurality of entities:
identifying a plurality of content item selection events in which said each entity participated;
aggregating data associated with each content item selection event of the plurality of content item selection events to generate aggregated data;
combining the aggregated data associated with each entity in the plurality of entities to generate combined aggregated data;
adjusting the combined aggregated data based on an actual performance value of the content delivery campaign to generate adjusted aggregated data;
in response to receiving input, determining, based on the adjusted aggregated data and the input, a simulated performance of the content delivery campaign.

2. The system of claim 1, wherein the data associated with each content item selection event lists a frequency for each bucket of a plurality of buckets, wherein each bucket of the plurality of buckets corresponds to range of bid prices or a specific bid price.

3. The system of claim 2, wherein:
determining an order of the plurality of buckets based on bid price;
aggregating comprises, for each subsequent bucket of the plurality of buckets, summing a frequency associated with said each subsequent bucket with one or more frequencies of one or more buckets, in the plurality of buckets, that are previous to said each subsequent bucket based on the order.

4. The system of claim 1, wherein the data associated with each content item selection event comprises determining a minimum winning bid associated with said each content item selection event.

5. The system of claim 1, wherein the plurality of entities includes one or more entities that have not participated in any content item selection event in which the content delivery campaign was a candidate for selection.

6. The system of claim 1, wherein:
the content delivery campaign is a first content delivery campaign;
the plurality of content item selection events of a particular entity in the plurality of entities includes one or more content item selection events that are associated with a second content delivery campaign that is different than the first content delivery campaign.

7. The system of claim 1, wherein the simulated performance is a particular number of impressions.

8. The system of claim 1, wherein the simulated performance is a particular entity selection rate.

9. The system of claim 1, wherein the simulated performance is a particular cost of the content delivery campaign.

10. The system of claim 1, wherein the instructions, when executed by the one or more processors, further cause:
causing a graph to be displayed, wherein the graph includes a line that reflects a relationship between bid price and simulated performance and that is based on the aggregated data.

11. The system of claim 10, wherein:
the graph includes a user-selectable graphical element that is movable, based on user input, along the line;
receiving the input comprises the user-selectable graphical element being moved to a first point on the line.

12. The system of claim 10, wherein adjusting the aggregated data comprises:
identifying a first simulated performance value based on the aggregated data and the actual performance value;
based on a difference between the first simulated performance value and the actual performance value, for each of multiple simulated performance values in the aggregated data:
determining an adjusted simulated performance value;
adding the adjusted simulated performance value to the adjusted aggregated data.

13. A system comprising:
one or more processors;
one or more storage media storing instructions which, when executed by the one or more processors, cause:
identifying a plurality of entities that satisfy one or more criteria associated with a content delivery campaign;
for each entity in the plurality of entities:
identifying a plurality of content item selection events in which said each entity participated;
aggregating data associated with each content item selection event of the plurality of content item selection events to generate aggregated data;
combining the aggregated data associated with each entity in the plurality of entities to generate combined aggregated data;
receiving first input that indicates a first value;
in response to receiving first input, determining, based on the combined aggregated data and the first value, a first simulated performance of the content delivery campaign;
receiving second input that indicates a second value;
in response to receiving second input, determining, based on the combined aggregated data and the second input, a second simulated performance of the content delivery campaign.

14. A method comprising:
identifying a plurality of entities that satisfy one or more criteria associated with a content delivery campaign;
for each entity in the plurality of entities:
identifying a plurality of content item selection events in which said each entity participated;
aggregating data associated with each content item selection event of the plurality of content item selection events to generate aggregated data;
combining the aggregated data associated with each entity in the plurality of entities to generate combined aggregated data;
adjusting the combined aggregated data based on an actual performance value of the content delivery campaign to generate adjusted aggregated data;
in response to receiving input, determining, based on the adjusted aggregated data and the input, a simulated performance of the content delivery campaign;
wherein the method is performed by one or more computing devices.

15. The method of claim 14, wherein the data associated with each content item selection event lists a frequency for each bucket of a plurality of buckets, wherein each bucket of the plurality of buckets corresponds to range of bid prices or a specific bid price.

16. The method of claim 15, wherein:
determining an order of the plurality of buckets based on bid price;
aggregating comprises, for each subsequent bucket of the plurality of buckets, summing a frequency associated with said each subsequent bucket with one or more frequencies of one or more buckets, in the plurality of buckets, that are previous to said each subsequent bucket based on the order.

17. The method of claim 14, wherein:
the content delivery campaign is a first content delivery campaign;
the plurality of content item selection events of a particular entity in the plurality of entities includes one or more content item selection events that are associated with a second content delivery campaign that is different than the first content delivery campaign.

18. The method of claim 14, wherein the simulated performance is one of a particular number of impressions, a particular entity selection rate, or a particular cost of the content delivery campaign.

19. The method of claim 14, further comprising:
causing a graph to be displayed, wherein the graph includes a line that reflects a relationship between bid price and simulated performance and that is based on the aggregated data;
wherein the graph includes a user-selectable graphical element that is movable, based on user input, along the line;
wherein receiving the input comprises the user-selectable graphical element being moved to a first point on the line.

20. The method of claim 14, further comprising:
causing a graph to be displayed, wherein the graph includes a line that reflects a relationship between bid price and simulated performance and that is based on the aggregated data;
wherein adjusting the aggregated data comprises:
identifying a first simulated performance value based on the aggregated data and the actual performance value;
based on a difference between the first simulated performance value and the actual performance value, for each of multiple simulated performance values in the aggregated data:
determining an adjusted simulated performance value;
adding the adjusted simulated performance value to the adjusted aggregated data.
